(19) United States
(12) Patent Application Publication
(10) Pub. No.: US 2024/0294109 A1
(43) Pub. Date: Sep. 5, 2024

(54) WIRELESS TRANSMITTING STRAP TENSION MONITORING DEVICE

(71) Applicant: John Andrew Schultz, Troy, MI (US)

(72) Inventor: John Andrew Schultz, Troy, MI (US)

(21) Appl. No.: 18/645,477

(22) Filed: Apr. 25, 2024

Related U.S. Application Data
(63) Continuation-in-part of application No. 17/323,272, filed on May 18, 2021, now Pat. No. 11,993,199.

(51) Int. Cl. B60P 7/08; G01L 5/04

(52) U.S. Cl. CPC B60P 7/0861; G01L 5/047

(57) ABSTRACT

A tension monitoring device that attaches or clamps onto to a tensioned cargo load securing strap and wirelessly communicates the tension level to the driver via a remote device, such as a mobile smartphone. One or more devices may be installed on a vehicle or trailer to be simultaneously monitoring the tension conditions during transit. The tension signal from the device is received and processed by the mobile smartphone application to display the real-time tension relative to unsafe levels and transmit alerts to the driver when an unsafe or undesired condition occurs. The tension monitoring device includes an electromechanical sensor and microprocessor, powered by a battery, and packaged inside two hinged weatherproof housings for the ability to clamp onto a tensioned cargo strap.

### CROSS-REFERENCE TO RELATED APPLICATIONS

This application is a Utility Patent application claiming priority to U.S. Provisional Patent Application Ser. No. 17/323,272, filed on Month May 18, 2021, which is incorporated by reference herein in its entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of monitoring devices, and more specifically to monitoring devices for roadway safety and for transporting goods.

### 2) Description of Related Art

The present disclosure relates to a device which monitors the tension in a strap or cable that secures cargo to vehicles such as, but not limited to, trailers, trucks, aircrafts, watercrafts, and other type of cargo transporting vehicles. More specifically, the device monitors and wirelessly communicates the real-time strap tension level to the driver through a remote device, such as a mobile smartphone application or other monitoring displays.

On road accidents caused by improperly secured or shifting heavy cargo loads are dangerous, costly, and commonplace. Cargo is often secured by a pre-set tensioned cargo strap attached to an open flatbed trailer prior to embarking on a trip to transport the cargo. Said cargo is then subjected to vehicle driving forces, such as road bumps, wind, turning, accelerating, and stopping, which cause the cargo to shift on the trailer and, therefore, alter the pre-set tension on the strap. This change in tension can become a danger to nearby motorists if the tension is loosened to the point where cargo can fall off the trailer, onto the roadway, and cause an accident. The result of this type of roadway accident ranges from costly physical property damage to death of motorists.

Moreover, a driver transporting cargo is not aware of or currently able to monitor changes to the tension of the strap without stopping the vehicle in route to physically inspect the strap tension. Not only is this visual roadside inspection unreliable, intermittent, and inefficient but it also subjects the driver to other roadside dangers such as passing traffic and inclement weather. Most drivers that are transporting cargo are doing so commercially and will lose productivity from said physical inspections or damaged cargo that falls off the trailer.

The device in this invention uses electromechanical technology to measure and monitor the tension of the strap in real-time and wirelessly communicate the tension level to the driver through a mobile smartphone application. This allows the driver to monitor the tension of the cargo straps more effectively and efficiently as compared to the conventional method of intermittently stopping to physically inspect strap tension. The device in this invention not only improves roadway safety to the driver and nearby motorists, but also improves the productivity of the driver by eliminating time wasted from a roadside physical inspection and mitigating the risk of cargo damage from falling off the trailer. The device will continuously monitor the tension of the cargo strap for the driver and alert the driver through a smartphone notification when the tension changes to an unsafe condition. This allows the driver to remain fully focused on transporting the cargo more safely and efficiently.

### BRIEF SUMMARY OF THE INVENTION

The instant invention in one form is directed to a cargo strap tension monitoring device for use with a cargo strap used for stabilizing a load on a vehicle. The cargo strap tension monitoring device includes an upper housing, a lower housing removably attached to the upper housing and a tension sensor for sensing tension of the cargo strap when the cargo strap tension monitoring device is engaged with the cargo strap. The cargo strap tension monitoring device includes a circuit board assembly having the tension sensor connected thereto and a battery for providing power to the circuit board assembly. The cargo strap tension monitoring device includes a first rigid support disposed in the lower housing extending toward the upper housing and a second rigid support disposed in the lower housing extending toward the upper housing, the first rigid support parallel to and spaced a distance from the second rigid support. The cargo strap tension monitoring device includes a cavity disposed between the first rigid support and the second rigid support and a tension sensor disposed in the upper housing, the tension sensor for providing a tension signal to the circuit board assembly. The tension sensor determines tension of the cargo strap when the cargo strap is engaged in the cargo strap tension monitoring device and the cargo strap tension monitoring device is in a closed position. The tension sensor may be a spring-loaded magnet holder movable within the first rigid support and the second rigid support wherein a spring-loaded magnet-holder includes a magnet interacting. The battery may be a rechargeable battery. The cargo strap tension monitoring device may include a battery charge port and a cover for preventing moisture or debris from entering the battery charge port. A hinge may rotatably connect the upper housing and the lower housing. The circuit board assembly may include at least one status indicator and the upper housing includes a status indicator window for allowing light from the at least one status indicator to be seen by a user. An external LED or an LED showing through an LED window on the upper housing may show advertising status, connection status, battery level, tension status, or other status. The circuit board assembly may be secured in the upper housing and the battery is connected to the circuit board assembly by a wire harness extending through the hinge. The cargo strap tension monitoring device may include at least one status indicator for providing visible indication of a status of the cargo strap tension monitoring device. The cargo strap tension monitoring device may include a latch for securing the upper housing to the lower housing. The latch may include a lock release button to allow the upper housing to be rotated from the lower housing. The cargo strap tension monitoring device may include a wired port for wired communication allowing programming of a microprocessor, the microprocessor mounted to the circuit board assembly. The microprocessor allows the cargo strap tension monitoring device to enter a sleep mode when the tension sensor detects that there is no cargo strap engaged with the cargo strap tension monitoring device. The microprocessor wakes the cargo strap tension monitoring device when a strap is detected. The microprocessor zeros out a magnetic field reading after assembly and determines tension based on a delta magnetic field calibration. The circuit board assembly may include a wireless communication module for the cargo strap tension monitoring device to communicate with a mobile device. Initial pairing of the mobile device and the wireless communication module is established and the mobile device is automatically connected to the cargo strap tension monitoring device when under tension. Zero tension recalibration may be available in an application on the mobile device. An alert is sent to the mobile device when there is an issue of stack ups, assembly differences, shifts over time, or other potential load problem. An application on the mobile device may include programming of tension thresholds based on starting initial tension and tension is monitored in real-time including soft warnings for near threshold and hard warning for beyond threshold.

One or more aspects of the exemplary embodiments below solve the problems and disadvantages described in the background section above.

In general, the real time tension monitoring system with wireless communication to a driver's smartphone device will eliminate the problems and disadvantages previously described.

One aspect of the exemplary embodiment is the real time tension measuring of a cargo strap. The tension is measured using a spring-loaded sensor, such as a magnet interacting with a hall effect sensor. When the device is installed on the strap, the strap is supported by two rigid supports and the spring-loaded sensor contacts the strap between them. The strap in tension will apply a force to the spring-loaded sensor, causing it to deflect in the device. This deflection is measured using a proximity sensor, such as hall effect sensor. This deflection of the spring-loaded sensor can be translated into a compression force acting against the spring. Therefore, using the measured sensor deflection, the known spring constant, and the known geometric relationship between the rigid supports and the sensor, the strap tension can be calculated. A microprocessor is used to process the deflection signal from the spring-loaded sensor and calculate a strap tension.

Another aspect of the exemplary embodiment is the wireless communication of the real-time tension measurement of the cargo strap. The microprocessor will use the calculated tension and wirelessly transmit the value to the paired smartphone application through protocol such as, but not limited to, Bluetooth, Bluetooth Low Energy, or Wi-Fi.

Another aspect of the exemplary embodiment is the smartphone application which processes the tension signal from the device to a remote display and alert system. Said application includes a graphical user interface display scale or gauge to indicate the real-time level of tension. In addition, the user can set the initial pre-set tension indicator on the display for comparison to the real time tension measurement. This indicates to the driver that the tension has increased or decreased relative to the initially set tension. The application uses calibrated values to determine driver alerts of unsafe conditions, such as a percentage of tension decrease from the initially set tension or a tension close to the minimum or maximum tension value.

Another aspect of the exemplary embodiment is the application's ability to store and instantly pair with known devices. Said application can have programmed devices recognized and paired automatically upon start up, minimizing the time for the driver to initialize the device and begin monitoring.

Another aspect of exemplary embodiment is the quick clamping and latch installation design. This design allows it to be quickly installed, removed, or moved between straps on a trailer. In addition, the device can be installed onto a loose or already secured and tensioned strap, without the need to feed the strap through the device or attached to mating strap connections. This saves the driver extended installation and setup time of the device. This also allows the device to be used with several different strap types and sizes.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is an illustration of a cargo load that is secured to a flatbed trailer with tensioned straps. The illustration also includes the tension monitoring system wirelessly communicating the tension signal to the mobile smartphone device located in the cab of the truck. There are two monitoring devices shown in this view, one on each strap.

FIG. 2 is a rear view of the truck and trailer to further illustrate the tension monitoring device installation and wireless communication. There is one tension monitoring device shown in this view.

FIG. 3 shows an isometric view of the monitoring device installed on a strap.

FIG. 4 shows an isometric view of the monitoring device installed on a strap, like FIG. 3, but from the other side.

FIG. 5 is an isometric view of the monitoring device that is un-clamped on the tensioned strap to illustrate the clamping installation on the strap.

FIG. 6A is a side view, parallel to the strap, of the monitoring device that is un-clamped to illustrate the installation on the strap and include a view of the internal electromechanical sensor mechanism.

FIG. 6B is a side view, parallel to the strap, of the monitoring device that is un-clamped to illustrate an alternate embodiment of the magnet holder;

FIG. 7 is a side view of the monitoring device, parallel to the strap, to illustrate the cross section as indicated in FIG. 8. In addition, FIG. 8 shows the internal electromechanical sensor mechanism and the device installed on the strap in the clamped state.

FIG. 8 is a cross section view of the device, sliced parallel to the strap according to FIG. 7, to further illustrate internal electromechanical sensor mechanism.

FIG. 9 illustrates the primary electrical circuitry of the device and the communication with the mobile smartphone application which displays tension levels.

FIG. 10 shows a hinge pin having a tension spring engaged with the upper housing and the lower housing.

FIG. 11 shows a latch having a lock release button with the latch in an unlocked position.

FIG. 12 shows a latch having a lock release button with the latch in a locked position.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

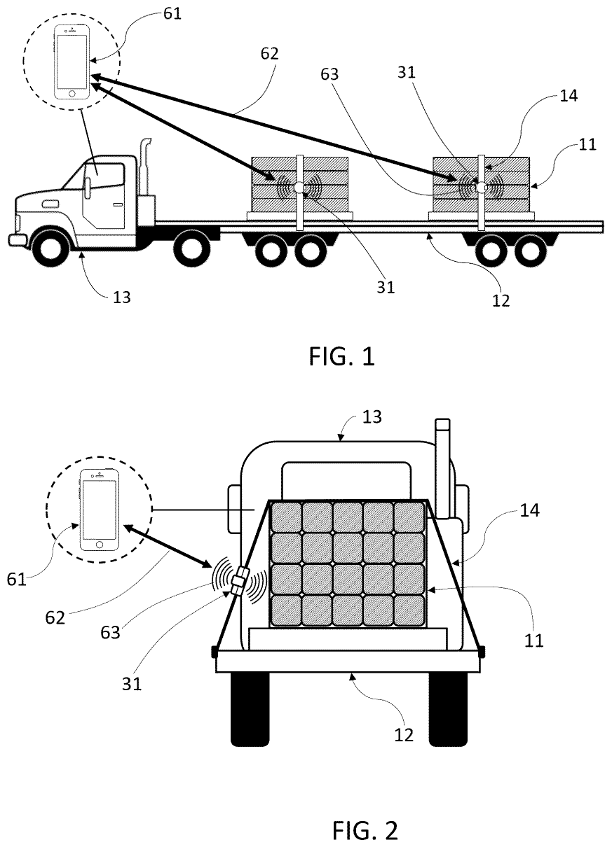

FIG. 1 shows a concept of the exemplary embodiment tension monitoring device 31 in use on a truck 13 and flatbed trailer 12 transporting cargo 11. Multiple cargo loads 11 are secured to the trailer 12 using a tensioned strap 14, such as a ratchet strap. This concept illustrates the use of multiple monitoring devices 31 wirelessly communicating 63 the tension signals 62 to the mobile smartphone 61. While in use, the mobile smartphone 61 is in the cab of the truck 13 displaying all tension signals 62 and alerts for the driver through the smartphone application.

FIG. 2 is an additional view of the exemplary embodiment tension monitoring device 31, similar to FIG. 1, but from the rear of the truck 13 and trailer 12. This further illustrates the device 31 in use and wirelessly communicating 63 the tension signal 62 to the mobile smartphone 61.

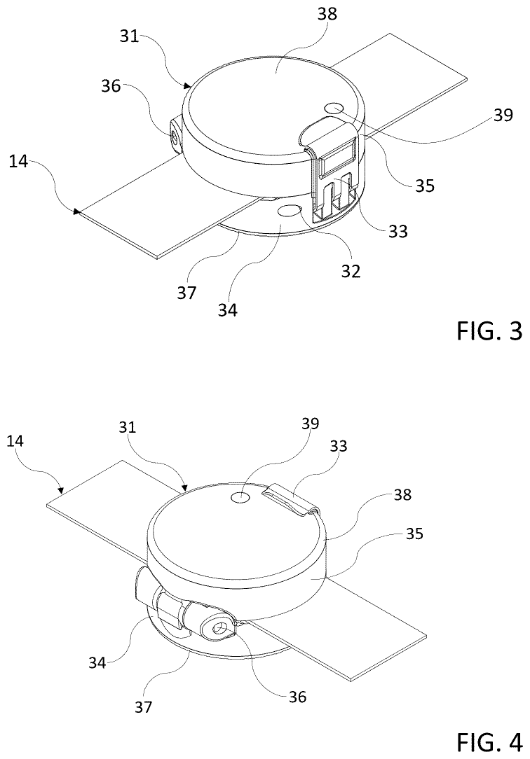

FIGS. 3 and 4 are isometric views of the tension monitoring device 31 installed on a strap 14. The device assembly 31 includes an upper housing 35 and upper housing cap 38 which are connected by a hinge having a hinge pin 36 to a lower housing 34 and lower housing cap 37. The device 31 is clamped and secured to the strap 14 when the upper 35 and lower 34 housings pivot about the hinge pin 36 and close tightly around the strap 14. The housing 35 and 34 are then latched together using the latch 33 which has a hinge pin 32 that is secured or integrated into the lower housing 34. An indicator window 39 is made of a transparent or translucent material to allow colored light indicators from the internal electronic circuitry to be seen by the user of the device 31. These are indicators such as, but not limited to, battery 49 charge status or wireless connection 63 status.

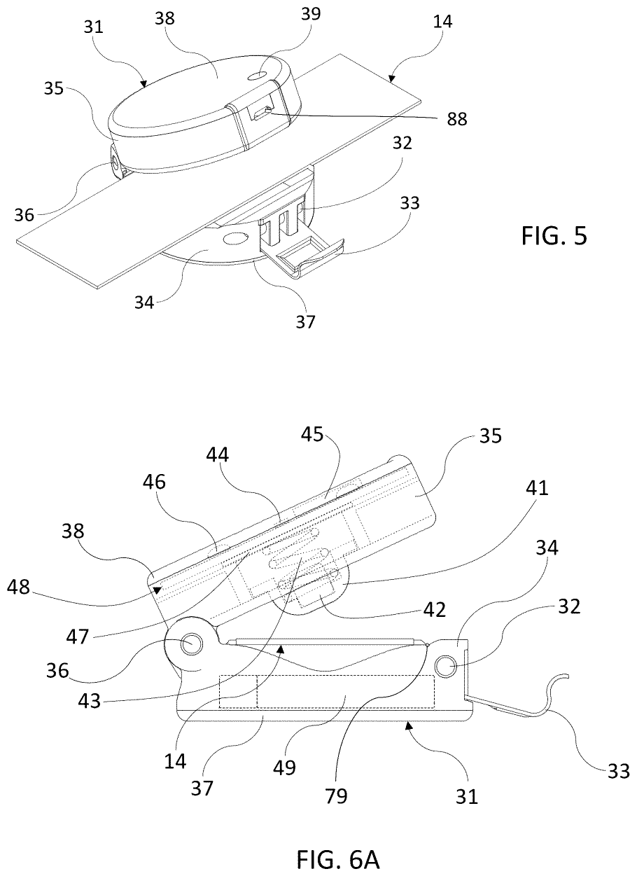

FIG. 5 is an isometric view and 6 is a side view of the tension monitoring device 31 while in the unclamped or unsecured state, prior to installation on the strap 14. From these views, it can be seen how the upper 35 and lower 34 housings pivot about hinge pin 36 as well as the latch 33 pivoting about the hinge 32. A charge port or USB port cover 88 seals a charge port or USB port from contamination from the weather or debris. A USB port may include the ability to charge the tension monitoring device or to program the microprocessor.

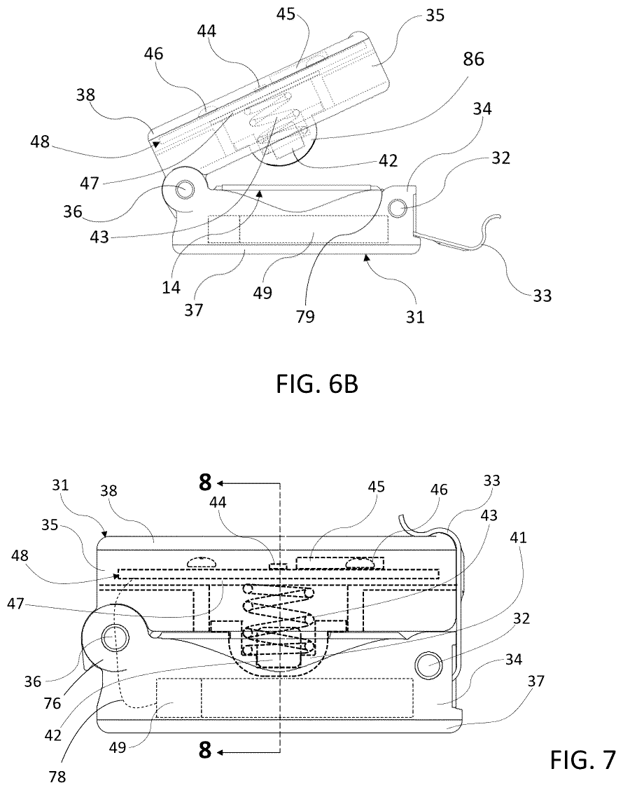

Further detail of the internal electromechanical sensor components can be seen in FIG. 6A. There is a printed circuit board assembly 48 which includes a sensor, such as a hall effect proximity sensor 44, as well as a microprocessor chip 45 that has wireless communication capabilities, such as Bluetooth or Wi-Fi. The electronic components are powered by a battery 49. The circuit board assembly 48 is secured to the upper housing 35 using fasteners 46. The circuit board assembly 48 is protected from the spring forces by the spring pad 47 which contacts the spring 43. The spring 43 forces the magnet 42 and magnet holder 41 against the strap 14. The magnetic flux from the magnet 41 interacts with the proximity sensor 44 and is used to generate a tension value within the microprocessor 45 to be wirelessly transmitted. The holder 41 contacts the strap 14 when the device 31 is in the installed and clamped state. The spring-loaded magnet holder 41 and magnet 42 will deflect into the upper housing 34 from the contact force of strap 14 in tension.

FIG. 6B shows a side view, parallel to the strap, of the monitoring device that is un-clamped to illustrate an alternate embodiment of the magnet holder 86. The magnet 42 is disposed in a magnet housing 86. The magnet housing 86 is a semi-sphere button for contacting the center the strap width and may provide additional support for preventing strap slippage. The remaining components used with magnet holder 86 are the same as shown in FIG. 6A.

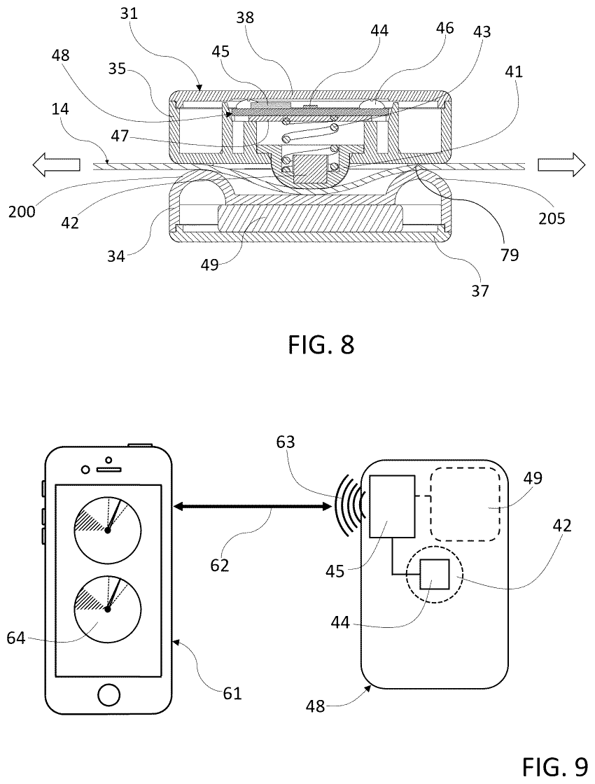

Further detail of the internal components and mechanism can be seen in FIGS. 7 and 8. FIG. 7 is a side view of the tension monitoring device 31 in the clamped state and installed on strap 14. The hinge pin 36 allows rotation of the upper housing in relation to the lower housing through integrated bushings 76 in the upper housing and the lower housing. The hinge pin 36 extends through the integrated bushings 76. A hinge or hinge assembly includes the hinge pin 36 and the integrated bushings 76 on both the upper housing and the lower housing. The wire harness 78 may pass through along any portion of the hinge assembly and may alternately pass through aligned openings in the hinge pin 36 and integrated bushings 76. Cut lines 8-8 in FIG. 7 describe the cross-section view shown in FIG. 8.

FIG. 8 shows the internal mechanism and how the strap 14 interacts with the spring-loaded magnet holder 41 and rigid supports 200, 205 that are integrated into lower housing 34. Using a known height and spacing between the two parallel rigid supports 200, 205 and a known spring constant in spring 43 contacting the strap 14, the tension in the strap 14 can be calculated from the change in proximity of the magnet 42 to the sensor 44. A ridged edge 79 or high friction rubber material secures the strap in a longitudinal direction between the upper housing and the lower housing.

FIG. 9 is a schematic of the primary components of the electrical circuit board assembly 48 and the interaction with the mobile smartphone 61 application. The primary components on the printed circuit board assembly 48 are the sensor 44 and microprocessor 45 with wireless capability 63. The assembly is powered by a battery 49. The general placement of the magnet 42 relative to the sensor 44 can also be seen. The magnet 42 and battery 49 are shown to be out of plane, compared to the circuit board assembly 48, as represented with the dotted lines. The microprocessor 45 wirelessly communicates 63 the tension information signal 62 to the mobile smartphone 61 application. The application contains monitoring software to process the signal 62 to display for the driver, such as, but not limited to, digital tension gauges 64 that indicate tension at the start of trip, acceptable variation in the pre-set tension, and a warning or alert feature indicating an unsafe or loss of tension condition.

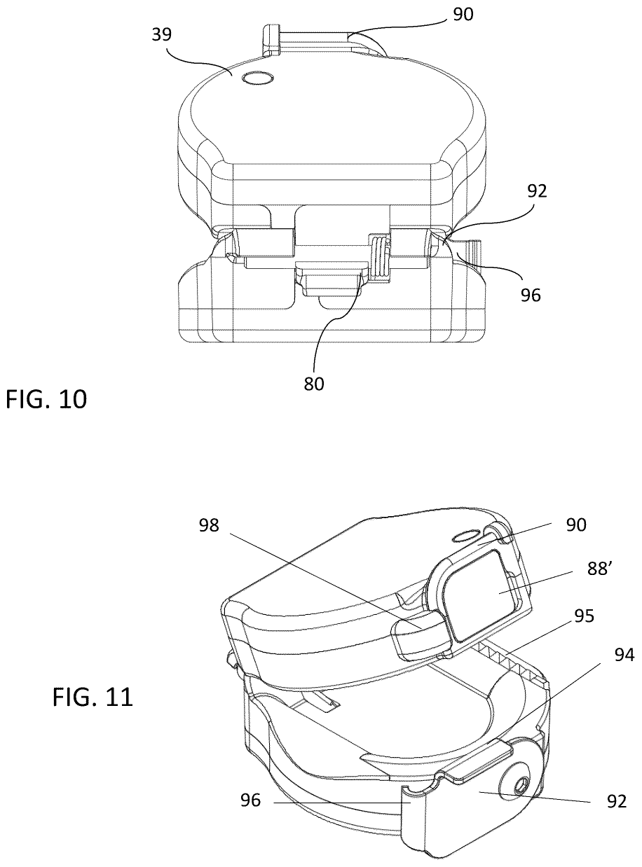

FIG. 10 shows the back of a hinge with a torsion spring 80 engaging the lower housing and the upper housing, the torsion spring 80 for biasing the tension monitoring devices in an open position. The upper housing includes an indicator window 39 and an upper catch plate 90. A lock plate 92 includes a catch flange 96 is shown in the unlocked position.

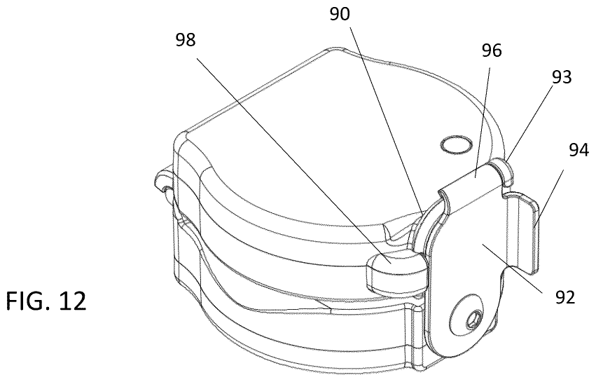

FIG. 11 shows a latch or latch assembly in an unlocked position with the cargo strap tension monitoring device in an open position. FIG. 12 shows the latch assembly in a locked position for securing the cargo strap tension monitoring device in a closed position. The latch assembly includes an upper catch 90 and a rotatable lock plate 92. The lock plate includes a fastening clasp 94 and a catch flange 96 engageable with the upper catch 90. A flange stop 93 prevents the flange from overshooting the upper catch 90. A lock plate release button 98 allows for release of the fastening clasp 94 from the upper catch 90. A strap grabbing edge 95 prevents the tension monitoring device from sliding along a strap.

The latch assembly may alternately be of any configuration with a lock release button preferred on the latch. A wire harness may extend through the hinge to connect the battery in the lower housing to the circuit board assembly in the upper housing. The wire harness may connect a charge port or USB port in the lower housing to the circuit board assembly in the upper housing. Preferably, the USB port is in the upper housing connected to the circuit board assembly. A dust cover 88′ for a charge port or USB port seals the charge port or USB port from contamination from the weather or debris. A USB port may include the ability to charge the tension monitoring device or to program the microprocessor.

One embodiment of the cargo strap tension monitoring device is for use with a cargo strap used for stabilizing a load on a vehicle, the cargo strap tension monitoring device. The cargo strap tension monitoring device includes an upper housing, a lower housing removably attached to the upper housing and a tension sensor for sensing tension of the cargo strap when the cargo strap tension monitoring device is engaged with the cargo strap. The cargo strap tension monitoring device includes a circuit board assembly having the tension sensor connected thereto, a battery for providing power to the circuit board assembly, a first rigid support disposed in the lower housing extending toward the upper housing and a second rigid support disposed in the lower housing extending toward the upper housing. The first rigid support is parallel to and spaced a distance from the second rigid support. The cargo strap tension monitoring device includes a cavity disposed between the first rigid support and the second rigid support and a tension sensor disposed in the upper housing, the tension sensor for providing a tension signal to the circuit board assembly. The tension sensor determines tension of the cargo strap when the cargo strap is engaged in the cargo strap tension monitoring device and the cargo strap tension monitoring device is in a closed position. The tension sensor is a spring-loaded magnet holder movable within the first rigid support and the second rigid support wherein a spring-loaded magnet-holder includes a magnet interacting. The battery is a rechargeable battery and the cargo strap tension monitoring device includes a battery charge port and a cover for preventing moisture from entering the battery charge port. A hinge rotatably connects the upper housing and the lower housing. The circuit board assembly is secured in the lower housing and the tension sensor is connected to the circuit board assembly by a wire harness extending through the hinge. Alternately, the circuit board assembly is secured in the upper housing and the battery is connected to the circuit board assembly by a wire harness extending through the hinge. The cargo strap tension monitoring device includes at least one status indicator for providing visible indication of a status of the cargo strap tension monitoring device. An external LED shows advertising status, connection status, battery level, tension status, or other status. The cargo strap tension monitoring device includes a latch for securing the upper housing to the lower housing. The latch includes a lock release button to allow the upper housing to be rotated from the lower housing. The cargo strap tension monitoring device includes a wired port for wired communication allowing programming of a microprocessor, the microprocessor mounted to the circuit board assembly. The microprocessor allows the cargo strap tension monitoring device to enter a sleep mode when the tension sensor detects that there is no cargo strap engaged with the cargo strap tension monitoring device. The microprocessor wakes the cargo strap tension monitoring device when a strap is detected. The microprocessor zeros out a magnetic field reading after assembly and determines tension based on a delta or change in magnetic field calibration. The circuit board assembly includes a wireless communication module for the cargo strap tension monitoring device to communicate with a mobile device. Initial pairing of the mobile device and the wireless communication module is established and the mobile device is automatically connected to the cargo strap tension monitoring device when under tension. Zero tension recalibration is available in an application on the mobile device. An alert is sent to the mobile device when there is an issue of stack ups, assembly differences, shifts over time, or other potential load problem. An application on the mobile device includes programming of tension thresholds based on starting initial tension and tension is monitored in real-time including soft warnings for near threshold and hard warning for beyond threshold.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A cargo strap tension monitoring device for use with a cargo strap used for stabilizing a load on a vehicle, the cargo strap tension monitoring device comprising:
an upper housing;
a lower housing removably attached to the upper housing;
a tension sensor for sensing tension of the cargo strap when the cargo strap tension monitoring device is engaged with the cargo strap;
a circuit board assembly having the tension sensor connected thereto;
a battery for providing power to the circuit board assembly;
a first rigid support disposed in the lower housing extending toward the upper housing and a second rigid support disposed in the lower housing extending toward the upper housing, the first rigid support parallel to and spaced a distance from the second rigid support;
a cavity disposed between the first rigid support and the second rigid support;
a tension sensor disposed in the upper housing, the tension sensor for providing a tension signal to the circuit board assembly;
wherein the tension sensor determines tension of the cargo strap when the cargo strap is engaged in the cargo strap tension monitoring device and the cargo strap tension monitoring device is in a closed position.

2. The cargo strap tension monitoring device according to claim 1 wherein the tension sensor is a spring-loaded magnet holder movable within the first rigid support and the second rigid support wherein a spring-loaded magnet-holder includes a magnet interacting.

3. The cargo strap tension monitoring device according to claim 1 wherein the battery is a rechargeable battery.

4. The cargo strap tension monitoring device according to claim 3 including a battery charge port and a cover for preventing contamination from entering the battery charge port.

5. The cargo strap tension monitoring device according to claim 1 wherein a hinge rotatably connects the upper housing and the lower housing and the hinge includes a torsion spring engaged with the upper housing and the lower housing for biasing the cargo strap monitoring device in an open position.

6. The cargo strap tension monitoring device according to claim 1 including a ridged edge for securing the strap in a longitudinal direction between the upper housing and the lower housing.

7. The cargo strap tension monitoring device according to claim 4 wherein the circuit board assembly is secured in the upper housing and the battery is connected to the circuit board assembly by a wire harness extending through the hinge.

8. The cargo strap tension monitoring device according to claim 1 including at least one status indicator for providing visible indication of a status of the cargo strap tension monitoring device and the upper housing includes a status indicator window for allowing light from the at least one status indicator to be seen by a user.

9. The cargo strap tension monitoring device according to claim 1 including a latch for securing the upper housing to the lower housing.

10. The cargo strap tension monitoring device according to claim 9 wherein the latch includes a lock release button to allow the upper housing to be rotated from the lower housing.

11. The cargo strap tension monitoring device according to claim 1 including a wired port for wired communication allowing programming of a microprocessor, the microprocessor mounted to the circuit board assembly.

12. The cargo strap tension monitoring device according to claim 11 wherein the microprocessor allows the cargo strap tension monitoring device to enter a sleep mode when the tension sensor detects that there is no cargo strap engaged with the cargo strap tension monitoring device.

13. The cargo strap tension monitoring device according to claim 11 wherein the microprocessor wakes the cargo strap tension monitoring device when a strap is detected.

14. The cargo strap tension monitoring device according to claim 11 wherein an external LED shows advertising status, connection status, battery level, tension status, or other status.

15. The cargo strap tension monitoring device according to claim 11 wherein the microprocessor zeros out a magnetic field reading after assembly and determines tension based on a delta magnetic field calibration.

16. The cargo strap tension monitoring device according to claim 1 wherein the circuit board assembly includes a wireless communication module for the cargo strap tension monitoring device to communicate with a mobile device.

17. The cargo strap tension monitoring device according to claim 16 wherein initial pairing of the mobile device and the wireless communication module is established and the mobile device is automatically connected to the cargo strap tension monitoring device when under tension.

18. The cargo strap tension monitoring device according to claim 16 wherein zero tension recalibration is available in an application on the mobile device.

19. The cargo strap tension monitoring device according to claim 16 wherein an alert is sent to the mobile device when there is an issue of stack ups, assembly differences, shifts over time, or other potential load problem.

20. The cargo strap tension monitoring device according to claim 16 wherein an application on the mobile device includes programming of tension thresholds based on starting initial tension and tension is monitored in real-time including soft warnings for near threshold and hard warning for beyond threshold.
